(19) United States
(12) Patent Application Publication
(10) Pub. No.: US 2016/0057211 A1
(43) Pub. Date: Feb. 25, 2016

(54) SYSTEM AND METHOD FOR SECURE INTEGRATION OF WEB AND MOBILE APPLICATIONS ON THE PUBLIC INTERNET WITH ENTERPRISE APPLICATION SERVERS IN THE PUBLIC, PRIVATE OR HYBRID CLOUD

(71) Applicant: Verasynth, Inc., Sunnyvale, CA (US)

(72) Inventors: Puneet Thapliyal, Sunnyvale, CA (US); Steven Bull, Sunnyvale, CA (US)

(21) Appl. No.: 14/832,387

(22) Filed: Aug. 21, 2015

Related U.S. Application Data
(60) Provisional application No. 62/040,103, filed on Aug. 21, 2014.
(60) Provisional application No. 62/040,110, filed on Aug. 21, 2014.
(60) Provisional application No. 62/040,118, filed on Aug. 21, 2014.

(51) Int. Cl. H04L 29/08; H04L 29/06

(52) U.S. Cl. CPC H04L 67/1002; H04L 67/02; H04L 67/42; H04L 63/029

(57) ABSTRACT

Methods and systems for secure integration of web and mobile applications with enterprise servers are described. The enterprise servers are accessible via the public Internet, yet communication endpoints of application servers are not exposed to the public Internet. In an embodiment a cloud DMZ server is placed between a web/mobile client and the enterprise. The cloud DMZ server communicates with the enterprise through its firewall (for example via one or more web sockets). In order for the API requests to be made and fulfilled, the enterprise does not need to keep open and inbound port. Because only outbound ports are used on the enterprise side for application layer communication, it is not possible to attack the enterprise in known ways (for example, SYN flood, TCP connect flood, Heartbleed, Poodle, Freak, Logjam, etc.).

### RELATED APPLICATIONS

This application claims priority from U.S. Provisional application No. 62/040,103, and from U.S. Provisional application No. 62/040,110, and from U.S. Provisional application No. 62/040,118, each of which is incorporated by reference herein in their entirety.

### BACKGROUND

Typically an enterprise has several legacy systems in its information technology (IT) infrastructure that support a range of business processes including Financials, Human Resources, Supply Chain, Procurement and Expenses. These systems may reside in the public cloud, or privately reside on the premises, behind a corporate firewall. They could be composed of popular application servers such as Apache or Nginx or could be packaged software from vendors such as Oracle™ and SAP™, and custom built software for the enterprise's unique business needs. With the increasing use of mobile devices to access enterprise systems, security has become an ever greater concern. Recently, there have been many attempts to place security infrastructure in the cloud. For example, security infrastructure is commonly architected via an in-line, proxy-based architecture. However, in-line, proxy-based architectures suffer various vulnerabilities.

With reference to Prior Art FIG. 1, vulnerabilities of prior security infrastructures are illustrated. System 100 includes a customer application server 106 that communicates with a web/mobile client 102 (shown as a mobile phone, but any known web or mobile client that can function in the same way is intended to be included) through an in-line proxy server 104. In-line proxy server 104 may also be generally referred to as a cloud server. Server 104 includes a security infrastructure. A web application firewall (WAF) is one example of such a security infrastructure.

Customer application server(s) 106 require open ports on the public Internet. When the client 102 communicates with the application server 106, it typically sends an HTTP request through the server 104. The HTTP request is then forwarded to an open inbound port of the server 106. This situation creates security issues. For example, open in-bound ports and listeners are susceptible to SYN flood, TCP connect flood, Heartbleed, Poodle, Freak, Logjam (just to name a few current threats in a constantly-evolving threat landscape).

Prior Art FIG. 2 illustrates another threat scenario for system 100. A “bad guy”, who might be a person or a program, can bypass the server 104 with relative ease and then attack the customer servers 106 directly. In this scenario, any security infrastructure associated with server 104 is rendered useless.

The emerging demand for Enterprise Mobile Apps require a new approach to integrate mobile devices to enterprise backend systems, securely, reliably and efficiently.

### BRIEF DESCRIPTION OF THE DRAWINGS

FIG. 1 is a diagram of a prior art enterprise system with mobile device access.

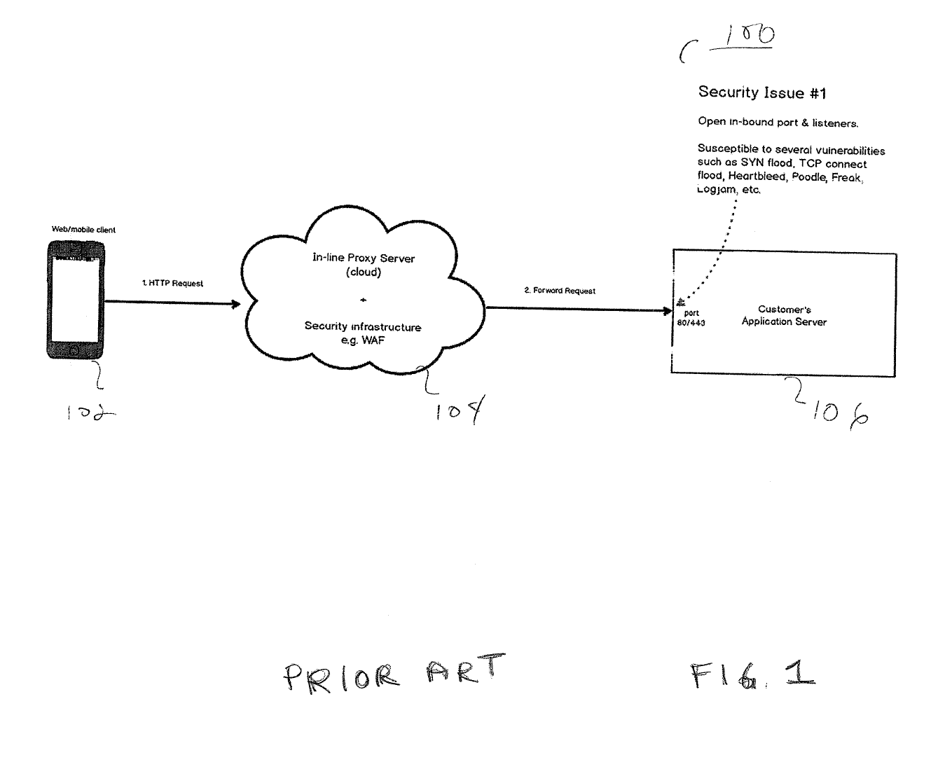

FIG. 2 is a diagram of a prior art enterprise system with mobile device access.

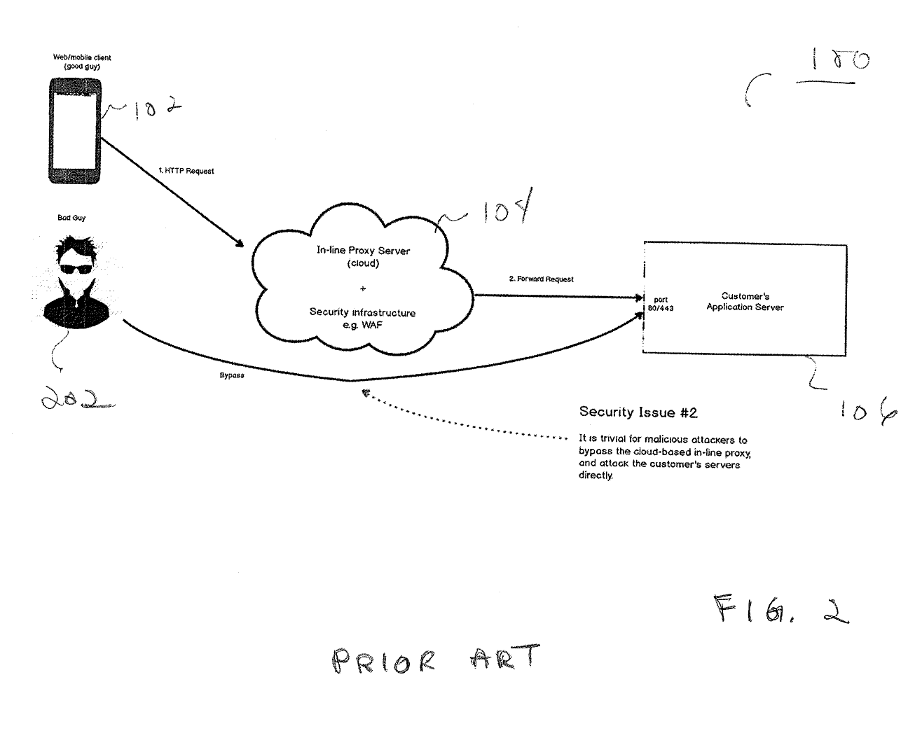

FIG. 3 is a diagram of an embodiment of a system for secure mobile device integration according to an embodiment.

FIG. 4 is a diagram of an embodiment of a system for secure mobile device integration according to an embodiment.

FIG. 5 is a diagram of an embodiment of a system for secure mobile device integration according to an embodiment.

FIG. 6 is diagram of an auto generating client side SDK according to an embodiment.

FIG. 7 is a diagram of an API parser according to an embodiment.

FIG. 8 is a diagram of an offline support injector according to an embodiment.

### DETAILED DESCRIPTION

Embodiments described herein include methods and systems that enable secure data interchange between a web/mobile client application/platform and the enterprise application servers. For example, a unidirectional, self-load-balancing firewall as a service (FaaS) cloud demilitarized zone (DMZ) application is described. The FaaS enables customer-side servers to be completely hidden from the perspective of the public Internet. A public IP address is not even required in order for an enterprise to use its servers as a first-class back-end to the web or mobile applications of the enterprise. As described below, it is possible for customer enterprises to close all in-bound firewall ports and shut down all listeners, yet maintain web/mobile accessibility.

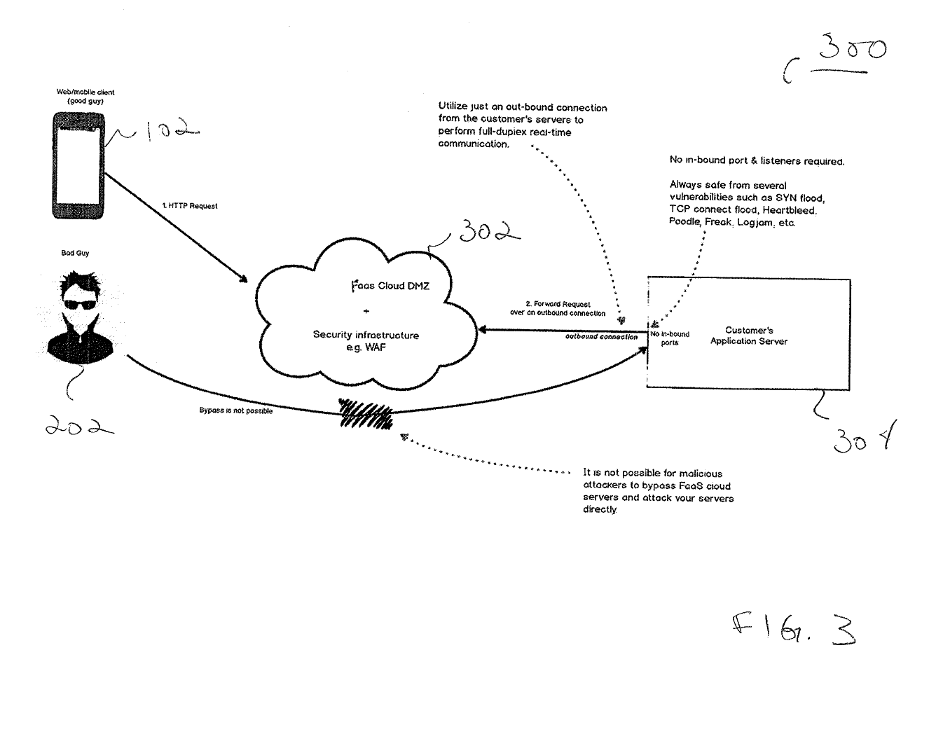

Referring to FIG. 3, an overview diagram of a system 300 is shown. System 300 illustrates the general approach employed in various embodiments. A web/mobile client 102 communicates with a customer application server 304 through a FaaS cloud DMZ 302 that includes a security infrastructure. For example, the security infrastructure could be a web application firewall (WAF) infrastructure. On the side of server 304, no in-bound ports are required in order to communicate with the web/mobile client 102. Therefore, it is not possible for malicious attackers to bypass the FaaS cloud servers (without going through the FaaS cloud DMZ 302). Only an out-bound connection is needed on the customer server 304 side. As will be described in greater detail below, embodiments make use of acknowledgment (ACK) packets in the reverse channel to send data payload to the customer server 304. This payload carries the REQUEST coming from the web/mobile client 102. Similarly, the REQUEST payload includes the RESPONSE that was generated by the customer server 304. In an embodiment, a web socket protocol is leveraged in order to effect this functionality. Said another way, a network protocol is used to carry additional data/information in server-to-server communication that it was not originally intended to convey.

In one embodiment, the REQUEST and ACK parts of the protocol are used to mark data payloads as RESPONSES. In this way, one of the servers does not need to open any in-bound ports.

The following steps illustrate a method according to one embodiment. Many other embodiments are possible that leverage different protocols, for example, or use different protocol signals. In this illustration, the Server A does not open in-bound ports, yet it is able to establish full-duplex real time communication with Server B.

Step #1: Only the Server B opens an in-bound port and listens for any incoming requests.

Server A has no in-bound ports open.
Server A only has an outbound port open. It can only send requests and receive ACKs, but it cannot receive any requests.

Step #2: Server A sends requests to Server B continuously and indefinitely. This establishes a persistent outbound connection. The data in the request is marked KEEP-ALIVE.

Step #3: Server B sends back ACK with a data payload marked as KEEP-ALIVE-ACK. Server A ignores these acknowledgements.

Step #4: To send a real request, Server A sends request to Server B and marks it as REQUEST.

Step #5: Server B processes the request and sends the response as an ACK. The data payload in the ACK is marked as RESPONSE.

Step #6: Server A receives the response as part of the ACK payload.

Step #7: When Server B needs to send a request to Server A, it looks for a KEEP-ALIVE request. In the ACK of that request, it sends the data payload marked as REQUEST.

Step #8: Server A receives the KEEP-ALIVE-ACK, and fined the data payload marked as REQUEST.

Step #9: Server A processes the request and generates a response.

Step #10: Server A sends a request to server B. However, the data in the request is marked as RESPONSE.

Step #11: Server B receives the request, and inspects the data payload to determine that it is a RESPONSE to its own request.

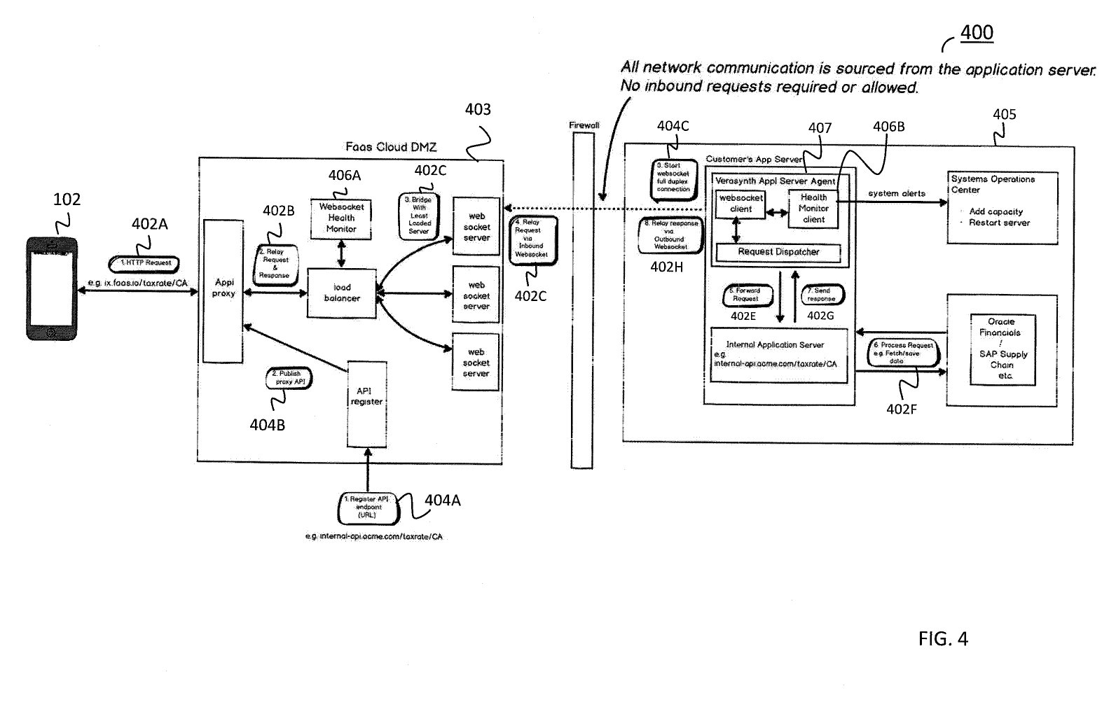

FIG. 4 is a block diagram of a system 400 according to an embodiment. System 400 includes a FaaS cloud DMZ 403 in communication with a web/mobile client 102. FaaS cloud DMZ 403 is also in communication with an enterprise system 405. The FaaS cloud DMZ 403 includes an Application proxy module, a load balancing module, a web socket health monitor 406A, and multiple web socket servers. The FaaS's cloud-based load balancer is used by the enterprise customer to deploy multiple Application servers to handle large volume of concurrent requests. Multiple Application servers could register with the FaaS cloud DMZ 403, for the same API Key. In that case, for each incoming request, the FaaS cloud DMZ 403 forwards it to the Application servers via a standard load-balancing algorithm. This helps distribute the load across multiple servers so the customer's enterprise systems can handle the volume.

This load balancing system does not require any configuration changes on the FaaS cloud DMZ 403, or customer application server images. The enterprise customer can simply launch additional application servers from the base image having the same API key. A new application server configures itself with the FaaS cloud DMZ 403. Additionally, the load balancer on the FaaS cloud DMZ 403 configures itself to start load balancing across multiple application servers registered for the same API Key. This gives IT administrators an extremely easy way to handle traffic loads and spikes.

If one of the Application Servers fails, the load balancer takes it out of rotation automatically, without the IT administrator taking any action. The load balancer also continuously monitors the state of the Application Server connections. If the connection is lost or impaired, the load balancer can route to another available Application server. This mechanism provides fault tolerance to the whole system such that health degradation on one link does not cause complete system failure.

FaaS cloud DMZ 403 further includes an API register in communication with the API proxy. FaaS cloud DMZ 403 sits outside the firewall of the enterprise. The internal API is registered in the FaaS cloud DMZ 403, which generates a corresponding public API endpoint for it. The public API is consumed by the mobile/web apps. This is termed as “API Reflection.”

When a request originates from a web app or a mobile device, the FaaS cloud DMZ 403 forwards it to the web socket server which relays it to the web socket client (API Server). Since the web socket server has a persistent connection open with the API server behind the firewall, there is a minimal lag induced in forwarding the request. In an embodiment, the persistent connection is secured by SSL, as it has been setup over HTTPS.

The response received from the API Server is relayed back to the originating caller on the mobile device or web app 102.

The enterprise system 405 includes a customer application server (or “app server”), and a systems operations center. Enterprise system 405 runs various enterprise software packages such as an Oracle™ Financials package and a SAP™ Supply Chain package (as examples). The customer app server includes embodiments of an application server agent 407 (also referred to as a Verasynth API server). The API server 407 executes various functions including a web socket client, a health monitor client 406B, and an API dispatcher. The mobile API server 407 sits inside the customer app server, behind the enterprise firewall. It opens a persistent web socket connection to the FaaS cloud DMZ 403 and listens for any incoming API requests. When an API request comes in, it invokes the actual API endpoint for that request, which resides inside the firewall, and not on the public internet. The response from the API is then relayed back to the FaaS cloud DMZ 403 via the same web socket connection.

All network communication from the mobile API server 407 is sourced from inside the firewall to the FaaS cloud DMZ 403 (outside the firewall). No inbound requests are required or allowed by the API server 407. In an embodiment, all communication to the FaaS cloud DMZ 403 is performed over secure HTTPS protocol that uses standard outbound port 443.

The API dispatcher accesses and dispatches custom APIs, including those related to the enterprise software packages.

As further described below with reference to a specific example, all network communication between the enterprise system 405 and the FaaS cloud DMZ 403 is sourced from the customer's app server 407. No inbound requests are required or allowed.

In an embodiment, a setup flow begins with registration of an API endpoint URL (404A). From the API registry, a proxy API 404B is published as shown. A full duplex web socket connection 404C is established from the customer's app server 407. A request/response flow according to an embodiment is as follows. When the web/mobile client makes an API call 402A, it is received by the API proxy of the FaaS cloud DMZ 403. The API proxy sends a relay request 402B (and similarly can receive a response) to the load balancer, which assigns the request (402C) to the least loaded one of the web socket servers. The request is relayed (402D) via an inbound web socket. In an embodiment this is performed by encoding on top of the web socket protocol, or using the web socket protocol channel for another communication purpose for which it was not originally designed. Then a server-side API is called (402E), which results in a fetch/save of legacy data (402F) between the customer's app server and the enterprise software packages. A response is then sent (402G) to the API dispatcher of the API server 407. This response is relayed (402H) via the outbound web socket.

The system also has a web socket health monitor 406A associated with the FaaS cloud DMZ 403, and a health monitor client 406B associated with the API server 407. The health of the system is monitored by these components, and when necessary, system alerts are sent by the health monitor client to a systems operations center on the enterprise system 405.

The health monitor on the FaaS cloud DMZ 403 monitors each web socket connection. It checks for connectivity as well as network lags. If the connection is down or the lag is beyond the desired threshold, the health monitor sends an alert back to the API Servers.

On the enterprise customer API Server side, the health monitor client listens for any system alerts coming in from the health monitor server. IT administrators can hook these system alerts to their system in the operations center. Based on the alert level, they could take automatic actions to keep the system stable (such as, adding capacity by spawning new API Servers, or restarting the app server, etc.).

This mechanism for Health Monitor and actionable system alerts help IT administrators to take immediate action in case of system degradation or failure.

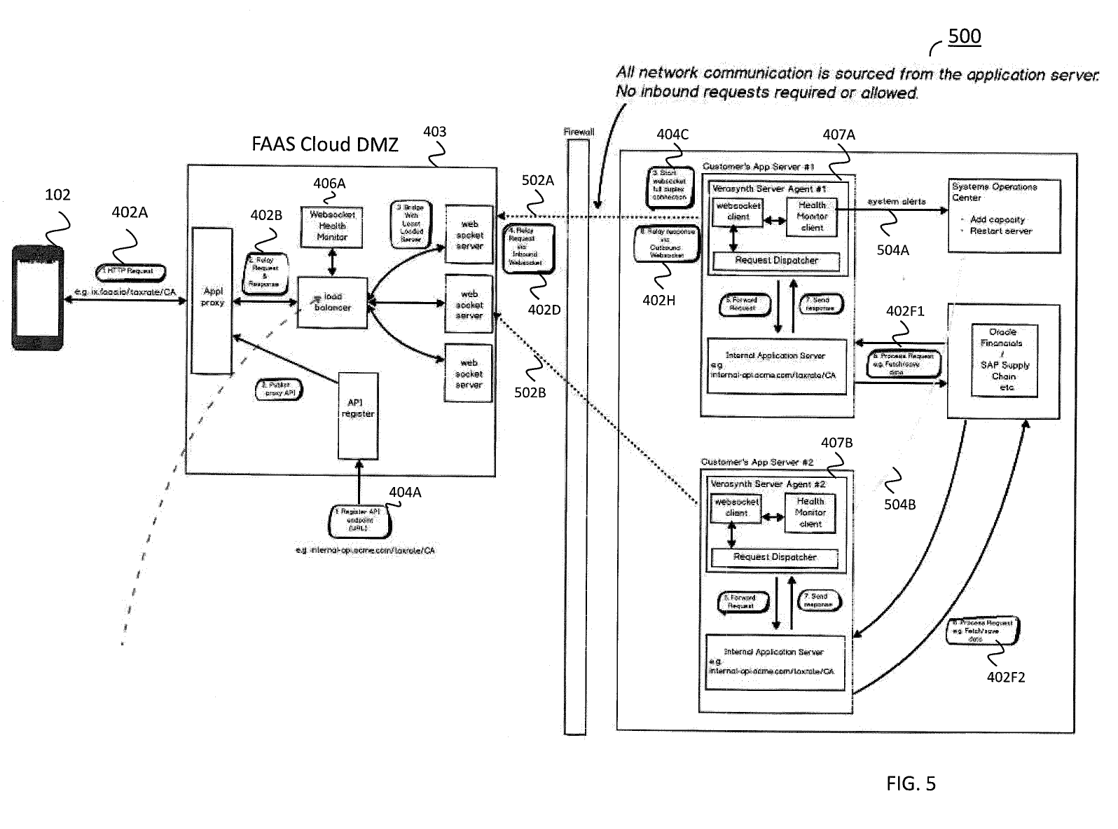

FIG. 5 is a diagram of a system embodiment showing multiple customers' app servers in communication with the FaaS cloud DMZ 403. The FaaS's DMZ cloud-based load balancer is used by the enterprise customer to deploy multiple application servers to handle large volume of concurrent requests. Multiple customer application servers register with the FaaS cloud DMZ 403, for the same API Key. In that case, for each incoming request, the FaaS cloud DMZ 403 forwards it to the application servers via a standard load-balancing algorithm. This helps distribute the load across multiple servers so the customer's systems could handle the volume. In the diagram, the load balancer receives requests from two customer app servers: app sever #1, and app server #2. App server #1 includes API server 407A, and app server #2 includes API server 407B. The load balancer assigns requests to web socket servers according to capacity.

If one of the Application Servers fails, the load balancer takes it out of rotation automatically, without the IT administrator taking any action. The load balancer also continuously monitors the state of the Application Server connections. If the connection is lost or impaired, the load balancer can route to another available Application server. This mechanism provides fault tolerance to the whole system where health degradation on one link does not cause complete system failure.

API servers 407A and 407B opens persistent web socket connection (502A and 502B, respectively) to the FaaS cloud DMZ 403 and listen for any incoming API requests. When an API request comes in, it invokes the actual API endpoint for that request, which resides inside the firewall, and not on the public internet. The response from the API is then relayed back to the FaaS cloud DMZ 403 via the same web socket connection.

Respective health monitors on API server 407A and 407B send system alerts to an enterprise systems operations center, which can take actions in response to the alerts, such as adding server capacity or restarting the server. API server 407A and 407B each access the enterprise software applications to fetch data and to store legacy data (402F1 and 402F2).

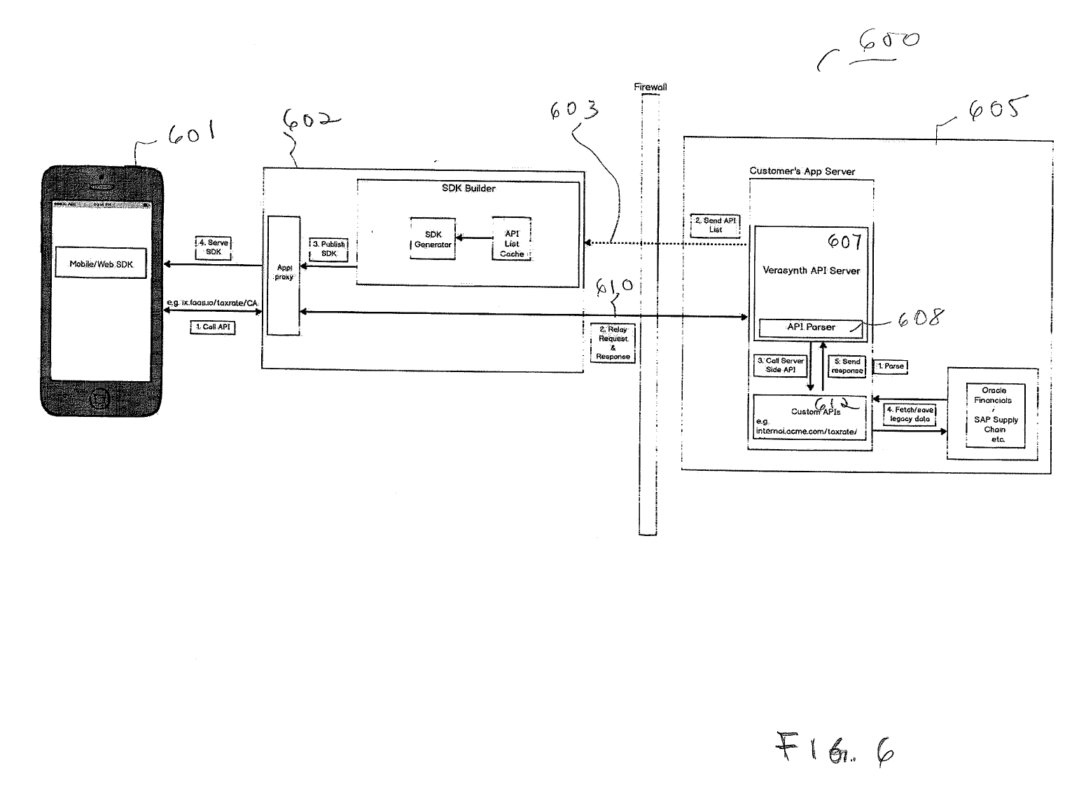

FIG. 6 is diagram of system embodiment 600 that auto generates client side software developer kit (SDK) application programming interfaces (APIs) according to an embodiment. This embodiment includes method and apparatus to auto-generate client side SDKs for each API written on the server side. This enables IT Developers to build enterprise apps rapidly, as it significantly reduces the level of effort to publish/consume APIs, and also helps access data from their legacy Information Systems in a consistent manner. A mobile SDK is automatically generated from the server side, matching the API signature and semantics. The SDK is server from FaaS cloud DMZ 602, obviating the need for developers to run a web server. The customer-side developer only needs to focus on writing server-side API logic (e.g., integrating into Oracle Financials™ or SAP inventory Management™. A corresponding SDK required by mobile developers is automatically generated, saving time and effort. The mobile developer also enjoys offline synch capabilities that are automatically built as part of the mobile APIs.

A communication device such as cell phone 601 hosts a mobile/web SDK. Mobile/web SDK communicates with a FaaS cloud DMZ 602 to access an enterprise system 605. A mobile API server (Verasynth API server) 607 sits inside the customer application server, behind the enterprise firewall. It listens for any incoming API requests. When an API request comes in, it invokes the actual API endpoint for that request and sends the request via connection 610. The response from the API is then relayed back to the FaaS cloud DMZ 602 via the same connection 610.

An API parser 608 is part of the API Server in an embodiment. A customer's API code that is present in a pre-defined folder (e.g., custom APIs 612) is parsed, and a list of public AP's and their parameters is prepared.

This list of APIs is then forwarded to the FaaS cloud DMZ 602 via an outbound connection 603, which would then generate the corresponding Client Side SDK.

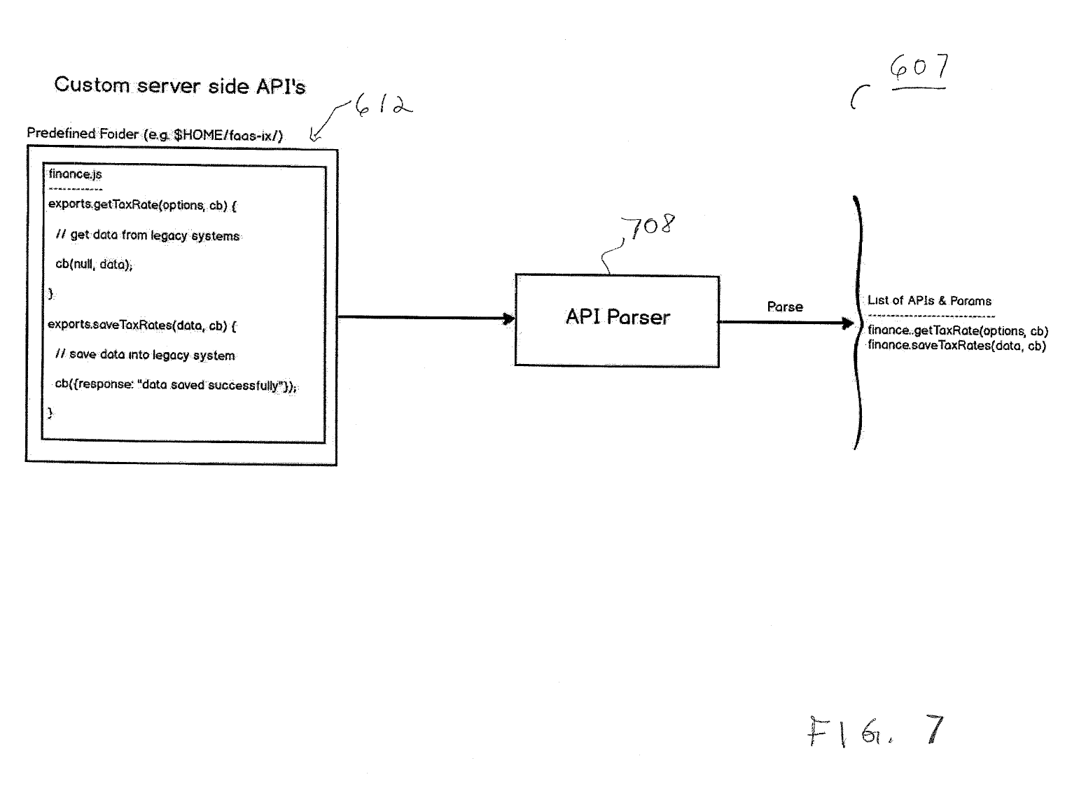

FIG. 7 is another diagram illustrating an API parser 708 according to an embodiment. As shown, data from custom API folder 612 is received by the API parser 708, which parses the data to generate a list of APIs and their parameters.

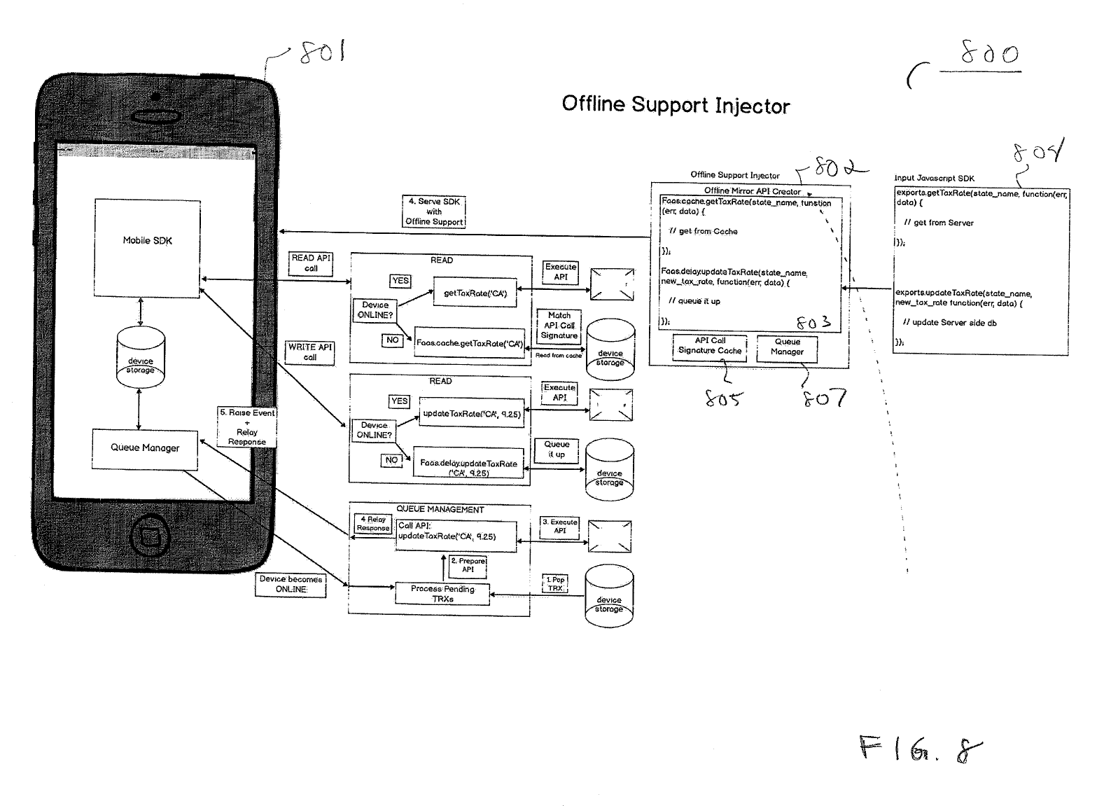

FIG. 8 is a diagram of an offline support injector according to an embodiment. In another aspect of an embodiment, a system includes an offline support injector subsystem 800. As an example, a method describe the method and apparatus for auto-injecting support for offline access capabilities into a given JavaScript SDK is described, but embodiments are not so limited. The offline access capabilities are especially useful on mobile devices during periods when Internet is not available (e.g. airplane journey) or in areas with spotty connectivity. The mobile API's generated as part of the SDK has transparent support for offline access. All data transfer via these APIs is cached locally in device storage. In case of no internet connection, the API server serves the data from the cache for read operations. Whereas for write operations, it syncs the local data with customer API servers as soon as the device comes online.

This enables the IT Developers to build robustness into their enterprise mobile apps, helps mobilize their Information Systems in a consistent manner, and improve overall user experience of their mobile apps.

An offline support injector 802 includes an offline mirror API creator 803, an API call signature cache 805, and a queue manager 807.

For each of the publically exported APIs in the input JavaScript SDK (commonJS), the offline mirror API creator 802 creates supporting APIs for offline capabilities:

For example:
Input API: getTaxRate(state_name, callback(err, data))

The supporting API's that would be created are as follows:
1. Faas.cache.getTaxRate(state_name, callback(err, data))
   This API checks for xxx in the cache (device local storage) first, and calls the real API if not found.
2. Fass.delay.getTaxRate(state_name, callback(err, data))
   The one helps queue the write transaction to the local device storage, for subsequent processing when the device comes back online.
3. Faas.delayCache.getTaxRate(state_name, callback(err, data))
   This API can handle both read and write, for the APIs that require such support.
4. Faas.callOrCache.getTaxRate(state_name, callback(err, data))
   This is similar to the 1^{St} API. It tries to make the real API call first, and if unable to checks for xxx in the cache.

To determine what data to return from the cache (in offline mode), the call signature of the API must exactly match that of a previous call. For example, if the API getTaxRate( ) is called with the parameter value of ‘CA’, the results of the API call are cached in the API call signature cache 805. When the device is offline, and another call to getTaxRate( ) is made with the same parameter value of ‘CA’, then instead of returning a network error, the ‘.cache’ API would return the data from the cache. This mechanism of call signatures helps in identifying whether the API has been called previously in online mode, and what data to fetch from the cache in the offline mode.

The queue manager 807 is part of the auto-generated SDK and helps with Write operations in offline mode. Along with the ‘.delay’ APIs, the queue manager 807 helps the mobile app developer build sophisticated offline support for their apps.

When a request originates for a Write operation, but the device is offline, the payload is saved into the local storage by the ‘.delay’ API. The queue manager 807 periodically checks for network status to see if the device is online or not. When the device becomes online, the queue manager 807 starts processing the transactions stored in the local storage in a first-in-first-Out (FIFO), MRU or other user defined manner. The actual API is called for each of the pending transactions. The response from the API is relayed to the app by raising an event, so app developers could build their own logic to display the results in the mobile app. In case of errors, separate events are raised so the app developers may handle them.

What is claimed is:

1. A method for integration of web and mobile applications, the method comprising:
a cloud DMZ receiving an application programming interface (API) call from a mobile device;
the cloud DMZ transmitting the API call through a web socket server;
the web socket server transmitting the API call through an enterprise firewall to an enterprise application server using a standard protocol;
a web socket client receiving the request and determining whether it is an API call, wherein determining comprises interpreting signals of the protocol in a way that is not standard.

2. The method of claim 1, further comprising the web socket client maintaining an open outbound port for communication with the cloud DMZ, and not opening an inbound port.

3. The method of claim 2, further comprising the web socket server maintaining an open inbound port.

4. The method of claim 2, wherein interpreting signals of the protocol comprises reading data payloads that are understood by the web socket client in a predetermined manner.

5. The method of claim 2, further comprising:
the web socket client interpreting the request as an API call; and
the web socket client transmitting the request to an API dispatcher.

6. The method of claim 5, further comprising:
the API dispatcher transmitting the request to an enterprise API storage, comprising fetching data from enterprise applications and enterprise custom API storage;
the API dispatcher receiving a response the enterprise application and enterprise custom API storage; and
the web socket client relaying the response to the outbound port.

7. The method of claim 2, wherein the cloud DMZ communicates with multiple enterprise application servers and multiple web socket clients using a standard protocol.

8. The method of claim 7, further comprising a load balancer of the cloud DMZ performing load balancing among multiple web socket servers.

9. The method of claim 2, further comprising a web socket health monitoring, wherein a web socket health monitor of the cloud DMZ monitors the health of one or more API servers and one or more API server connections.

10. The method of claim 7, further comprising an automatic configuration process wherein an API server that is newly launched by the enterprise uses a same existing API key, and configures itself with the cloud DMZ.

11. The method of claim 3, further comprising:
the web socket client listening to incoming API requests via a persistent web socket connection to the cloud DMZ; and
in response to receiving an API request, the web socket client invoking an API endpoint for that request, wherein the API resides inside the enterprise firewall and is not exposed to the public Internet.

12. The method of claim 11, further comprising the web socket client relaying a response to the API request via the persistent web socket connection.

13. A system for secure integration of web and mobile applications, the system comprising:
a cloud DMZ comprising a load balancer, a web socket health monitor, and at least one web socket server;
at least one enterprise application server, wherein an application programming interface(API) server resides on the at least one enterprise application server, the API server comprising,
a web socket client;
an API dispatcher; and
a health monitor client; and
wherein the cloud DMZ is interposed between a web/mobile device hosting a web/mobile client and the at least one enterprise application server, and wherein the at least one web socket server and the at least one API server communicate API requests and responses to and from the web/mobile client and the at least one enterprise application server using an outbound port on the at least one enterprise application server, the at least one enterprise application server never using an inbound port for API requests and responses.

14. The system of claim 14, wherein the cloud DMZ further comprises a web application firewall (WAF) infrastructure.

15. The system of claim 13, wherein the cloud DMZ further comprises an API proxy module in communication with the web/mobile device.

16. A non-transient computer-readable medium having instructions thereon, that when executed in an enterprise application server and cloud DMZ, cause the performance of an API communication method between the enterprise application server and a web/mobile device that is outside a firewall of the enterprise application server, the method comprising:
the cloud DMZ receiving an application programming interface (API) call from a mobile device;
the cloud DMZ transmitting the API call through a web socket server;
the web socket server transmitting the API call through the firewall to the enterprise application server using a standard protocol;
a web socket client receiving the request and determining whether it is an API call, wherein determining comprises interpreting signals of the protocol in a way that is not standard.

17. The method of claim 16, further comprising the web socket client maintaining an open outbound port for communication with the cloud DMZ, and not opening an inbound port.

18. The method of claim 17, further comprising the web socket server maintaining an open inbound port.

19. The method of claim 17, wherein interpreting signals of the protocol comprises reading data payloads that are understood by the web socket client in a predetermined manner.

20. The method of claim 17, further comprising:
the web socket client interpreting the request as an API call; and
the web socket client transmitting the request to an API dispatcher.

21. The method of claim 20, further comprising:
the API dispatcher transmitting the request to an enterprise API storage, comprising fetching data from enterprise applications and enterprise custom API storage;
the API dispatcher receiving a response the enterprise application and enterprise custom API storage; and
the web socket client relaying the response to the outbound port.

23. The method of claim 17, further comprising a web socket health monitoring, wherein a web socket health monitor of the cloud DMZ monitors the health of one or more API servers and one or more API server connections.

24. The method of claim 18, further comprising:
the web socket client listening to incoming API requests via a persistent web socket connection to the cloud DMZ; and
in response to receiving an API request, the web socket client invoking an API endpoint for that request, wherein the API resides inside the enterprise firewall and is not exposed to the public Internet.

25. The method of claim 24, further comprising the web socket client relaying a response to the API request via the persistent web socket connection.
